(19) United States
(12) Patent Application Publication
(10) Pub. No.: US 2026/0186121 A1
(43) Pub. Date: Jul. 2, 2026

(54) USE OF A VEHICLE UWB SYSTEM

(71) Applicant: VALEO COMFORT AND DRIVING ASSISTANCE, Créteil (FR)

(72) Inventors: Onur Oguz, Créteil (FR); Georges Djokic, Créteil (FR); Eric Menard, Créteil (FR)

(73) Assignee: VALEO COMFORT AND DRIVING ASSISTANCE, Créteil (FR)

(21) Appl. No.: 18/858,633

(22) PCT Filed: Mar. 24, 2023
(86) PCT No.: PCT/EP2023/057716

§ 371 Date: Oct. 21, 2024

(30) Foreign Application Priority Data
Apr. 21, 2022 (FR) FR2203733

(51) Int. Cl. G01S 13/76; G01S 7/02; G01S 13/02

(52) U.S. Cl. CPC G01S 13/765; G01S 13/0209; G01S 7/023

(57) ABSTRACT

A method of use of a vehicle UWB system including one or more UWB sensors and having enrolled one or more identifiers is provided. The method includes periodically one or more locations. The one or more locations include, for each respective identifier, at least one respective location of the respective identifier with the one or more UWB sensors. The one or more locations are temporally separated. The method includes periodically a plurality of radar measurements. The plurality of radar measurements includes, for at least one respective UWB sensor, a plurality of respective radar measurements. The number of respective radar measurements is, for each identifier, greater than the number of at least one respective location of the identifier with the one or more UWB sensors.

### TECHNICAL FIELD

The present disclosure relates to use of a vehicle UWB system (UWB standing for Ultra-Wide Band).

### TECHNICAL BACKGROUND

At the present time some vehicles are equipped with a UWB system comprising one or more UWB sensors that are installed in the vehicle. The UWB system enrolls one or more identifiers, and the UWB system is then able to locate the one or more identifiers with the one or more UWB sensors. However, use of the UWB system is generally limited to this location functionality.

For this reason, there is a need for an improved vehicle UWB system.

### SUMMARY

To this end, a method of use of a vehicle UWB system is provided, the system comprising one or more UWB sensors and having enrolled one or more identifiers. This method is referred to below as the “method of use”, or simply “method”. The method comprises periodically one or more locations. The one or more locations include, for each respective identifier, at least one respective location of the respective identifier with the one or more UWB sensors. The one or more locations are temporally separated. The method comprises periodically a plurality of radar measurements. The plurality of radar measurements includes, for at least one respective UWB sensor, a plurality of respective radar measurements. The number of respective radar measurements is, for each identifier, greater than the number of at least one respective location of the identifier with the one or more UWB sensors.

Each respective location of a respective identifier with the one or more UWB sensors may comprise UWB exchanges each consisting of transmissions of frames between the respective identifier and the one or more UWB sensors. The plurality of radar measurements may comprise, for each respective radar measurement of a respective UWB sensor, emission of a frame by the respective UWB sensor, temporally separated from the transmissions of frames between the respective UWB sensor and the respective identifier during the UWB exchanges.

Each respective location of a respective identifier with the one or more UWB sensors may be carried out within a time interval consisting of a series of time slots. The one or more identifiers may comprise a priority identifier. The frames of each radar measurement may be emitted within one of the time slots of the priority identifier.

The transmissions of frames of the UWB exchanges between the priority identifier and the one or more UWB sensors may be carried out within slots of the series belonging to a first group. The series may comprise a second group of one or more slots outside the first group. At least one frame of the radar measurement may be emitted within one of the one or more slots of the second group.

Each frame of one of the UWB exchanges may be transmitted at the start of a respective time slot. Each frame of the radar measurement of the UWB sensor may be emitted at the end of a respective time slot. For each UWB sensor, the respective time slots in which the UWB sensor emits a frame of a radar measurement may be different from the respective time slots in which a frame of a UWB exchange is transmitted between one of the one or more identifiers and the UWB sensor.

The frames of the radar measurement may be emitted orthogonally to the transmitted frames of the UWB exchanges.

Each respective location of a respective identifier with the one or more UWB sensors may comprise transmissions of frames from the identifier to each UWB sensor in slots at the start and end of the series and, for each UWB sensor, transmission of a frame from the UWB sensor to the respective identifier in a respective slot in the middle of the series.

A scheduling method is also provided, which is implemented by a vehicle UWB system comprising one or more UWB sensors and having enrolled one or more identifiers, for a use of the system according to the method of use. This method is referred to below as the “scheduling method”. The scheduling method comprises planning of the one or more locations and the plurality of radar measurements.

The scheduling method may comprise detection of at least one scheduling in a given time slot of emission of a frame of the radar measurement and of transmission of a frame of one of the UWB exchanges. The scheduling method may also comprise, for each of the at least one scheduling detected in a given time slot, a temporal shift of the scheduling of the emission of the frame of the radar measurement with respect to the transmission of the frame of the one of the UWB exchanges.

A vehicle UWB system is also provided. The UWB system comprises one or more UWB sensors. The system is configured to be used according to the method of use and/or to execute the scheduling method.

A UWB sensor for a vehicle UWB system is also provided. The UWB sensor is configured for a use of the system according to the method of use and/or to execute the scheduling method.

A computer program is also provided. The computer program comprises program-code instructions for execution of the method of use and/or of the scheduling method, when said program is executed by a processor.

### BRIEF DESCRIPTION OF THE FIGURES

Non-limiting examples will be described with reference to the following figures:

FIG. 1 shows one example of planning of a plurality of locations.

FIG. 2 shows one example of a location carried out within a time interval consisting of a series of time slots.

FIG. 3 shows a first example of planning of a plurality of radar measurements.

FIG. 4 shows a second example of planning of a plurality of radar measurements.

FIG. 5 shows a third example of planning of a plurality of radar measurements.

FIG. 6 shows one example of a use of the vehicle based on locations and radar measurements planned according to the scheduling method.

FIG. 7 shows one example of location of an identifier with the one or more UWB sensors.

FIG. 8 shows one example of determination of the number of time slots of each series for an identifier.

FIG. 9 shows examples of frames.

FIG. 10 illustrates one example of a vehicle UWB system.

### DETAILED DESCRIPTION

A method of use of a vehicle UWB system comprising one or more UWB sensors and having enrolled one or more identifiers is provided. This method is referred to below as the “method of use”, or simply “method”. The method comprises a number of actions, which are carried out periodically. The actions comprise one or more locations. The one or more locations include, for each respective identifier, at least one respective location of the respective identifier with the one or more UWB sensors. The one or more locations are temporally separated. The actions also comprise a plurality of radar measurements. The plurality of radar measurements includes, for at least one respective UWB sensor, a plurality of respective radar measurements. The number (per period) of respective radar measurements is, for each identifier, (strictly) greater than the number (per period) of at least one respective location of the identifier with the one or more UWB sensors.

UWB may refer to a communication protocol, for example the one specified by IEEE 802.15.4.

A scheduling method, which may be executed prior to the method of use, is also provided. The scheduling method may comprise planning of the one or more locations and the plurality of radar measurements. The scheduling method may be executed once before execution of the method of use, and the method of use may comprise, periodically, and over a plurality of periods, the one or more locations and the plurality of radar measurements according to the plan defined by the scheduling method. Alternatively, the scheduling method may be executed a plurality of times during execution of the method of use, for example each time a predetermined number of periods has elapsed, or after a specific event (for example detection of a new identifier). Each new execution of the scheduling method may replan the one or more locations and the plurality of radar measurements, and, after each execution of the scheduling method, the method of use may comprise the one or more locations and the plurality of radar measurements according to the plan defined by the new execution of the scheduling method.

The method enables improved use of the vehicle UWB system.

Specifically, the method makes it possible to carry out, periodically, one or more UWB locations and, in parallel, the plurality of radar measurements. This means that the one or more UWB locations and the plurality of radar measurements are carried out in the same time interval (or “period”), and that this interval reoccurs over time. “In parallel” therefore means that, in this time interval, which reoccurs, the method of use allows both one or more UWB locations and a plurality of radar measurements.

Furthermore, the method allows one or more given sensors to be used both to do the location and also to make the radar measurements. Specifically, the at least one UWB sensor is involved both in each of the locations and also in a plurality of respective radar measurements. In other words, each respective UWB sensor carrying out radar measurements is also involved in the one or more locations, and thus has a dual function. This allows the number of UWB sensors in the system to be optimized, and avoids using one or more additional UWB sensors to carry out any desired radar measurements. In other words, the method makes it possible to exploit UWB sensors that already exist, for a radar functionality additional to their initial UWB location functionality.

Moreover, the method allows fine and precise radar measurements. Specifically, in each period, the number of radar measurements, for the at least one respective UWB sensor, is strictly greater than the number of at least one location of each identifier. This higher number of radar measurements per period, i.e. this higher sampling frequency, ensures a relatively high radar measurement precision. Specifically, a relatively high sampling frequency allows relatively fine radar detection, for example making it possible to precisely detect movements and/or small movements.

The method may comprise one or more uses of the one or more locations and/or of the plurality of radar measurements. For example, one use may be detection of an abnormal event in the vehicle, such as a child being left in the vehicle. For this purpose, the method may comprise detection of chest movements inside the vehicle (as the child breathes), for example after the vehicle has been closed, and triggering an alarm. In other examples, the use may be gesture detection. For example, UWB sensors may be located on the rear bumper of the vehicle, and the method may comprise detection by the UWB sensors located on the rear bumper of the vehicle of a foot movement to open the boot of the vehicle (for example, a foot movement resembling a kick) and opening the boot after detection of the foot movement.

For each identifier, and for each period, the number of radar measurements per UWB sensor is strictly equal to or greater than the number of location(s) of each identifier. The number of radar measurements may for example be at least two times greater than the number of at least one location. Each radar measurement may comprise transmission of a frame by the UWB sensor, and the frequency of the frame transmissions may be greater than a minimum frequency, for example greater than 1 Hz, 10 Hz or 100 Hz.

A location of an identifier may comprise determination of a relative position of the respective identifier with respect to the UWB system. For example, the location may comprise, for each UWB sensor, a respective distance measurement between the identifier and the UWB sensor. The distance measurement may comprise one or more UWB exchanges each consisting of transmission frames between the identifier and the UWB sensor (for example, from the identifier to the UWB sensor and/or from the UWB sensor to the identifier). The location may then comprise determination of the relative position of the identifier with respect to the UWB system, based on the respective distance measurements.

A radar measurement by a UWB sensor may comprise a phase of emission of a frame by the UWB sensor. The emission of the frame of the radar measurement may have a duration of between 100 and 520 microseconds. A radar measurement may also comprise a listening phase. The listening phase may start simultaneously with the emission phase (or just after). During this phase, the radar measurement may comprise detection of a return signal corresponding to the frame of the radar measurement that was emitted and that has now been reflected by one or more objects located around the UWB sensor. Specifically, an emitted frame may reflect from one or more objects, and therefore return towards the UWB sensor, which may then detect it as a return signal (also called a radar echo). The radar measurement may then comprise detection of a presence of the one or more objects and/or determination of a position and/or speed of the one or more objects, based on the emitted frame and the return signal.

The one or more locations are temporally separated. This means that, at any given time, only one location is carried out. For example, the one or more locations may be carried out successively, one after the other. In other words, each location may be carried out within a respective time interval, and the respective time intervals of each of the locations may be temporally distinct. Two successive time intervals may follow one another directly (i.e. the end of one location may correspond to the start of the following location), or indeed they may be spaced apart by a given duration.

Periodically means that, in a given time interval, the method comprises both the one or more locations and the plurality of radar measurements, and that the method repeats at regular intervals of this given time interval the one or more locations and the plurality of radar measurements. The period represents the duration of this given time interval during which the locations and the plurality of radar measurements are carried out.

The UWB system may have enrolled one or more identifiers other than the one or more identifiers involved in the method. The method may detect that the one or more other identifiers are not within range of the vehicle, and therefore decide not to locate them.

For each identifier of the one or more identifiers, the number of at least one respective location of the identifier per period may depend on the identifier. For example, the method may comprise, before the start of the at least one respective location, an exchange with the identifier to determine the number of at least one respective location per period. The exchange may comprise transmission, from the identifier to the UWB system, of frequency information of the identifier and a computation, by the UWB system, of the number of at least one respective location per period depending on the frequency information. The frequency information may be a frequency or a duration that is specific to the identifier.

The term “identifier” designates a mobile object identifiable by the vehicle, and for example the location of which permits or not one or more (specific) actions of the vehicle. For example, the identifier may be used to open the vehicle and/or start the engine of the vehicle. For example, the method may include opening the vehicle when the identifier is located in proximity to the vehicle, or turning on the engine when the identifier is in the vehicle. The method may involve as identifier(s) one or more keys and/or one or more smart devices such as a mobile phone.

The emission of each frame of a radar measurement may be temporally separated from the transmissions of frames during the UWB exchanges. The emissions of the frames during the radar measurements may therefore be interleaved with the transmissions of frames during the UWB exchanges.

For example, the scheduling method may comprise planning of the one or more locations and the plurality of radar measurements so that the emissions of the frames during each radar measurement are interleaved with the transmissions of frames during the UWB exchanges of each location. “Interleaved” means that the emissions of the frames may be planned for time intervals distinct from those for which the frame transmissions are planned (without any overlap).

The planning may be done for a duration, for example a duration equal to one period, or to several times the period. The planning may comprise determination, in this duration, for each of the one or more locations and each of the radar measurements of the plurality, of a respective time interval in which the location or radar measurement is to be carried out. For example, the planning may include determination of a respective time interval for each location then determination, for each radar measurement, of a respective time interval depending on the respective time intervals of the one or more locations, or conversely the planning may comprise determination of a respective time interval for each radar measurement and then, for each location, determination of a respective time interval depending on the respective time intervals of the radar measurements.

The duration for which the planning is done may correspond to a time that has not yet elapsed, i.e. to a duration to come with respect to the time at which the planning is carried out. The length of the duration may be set or indeed vary, for example depending on the environment of the vehicle.

Each UWB exchange may consist of transmissions of frames between the identifier and the one or more UWB sensors. The planning of the one or more locations may comprise, for each location, determination of a temporal position for each of the frame transmissions of each of the UWB exchanges of the location. A transmission of a frame of a UWB exchange may have a duration of between 60 and 137 microseconds.

The determination of a temporal position for a frame transmission may comprise determination of a time at which transmission of the frame starts and ends. The time between the start and end may be equal to a transmission duration. The transmission duration may be dependent on a length of the frame and on a transmission rate. The position of the start and end may be dependent on the length of the frame and/or on transmission rate.

The planning of the plurality of radar measurements may comprise, for each radar measurement, determination of a temporal position for the radar measurement. Temporal position may be determined for a radar measurement in a way equivalent to how it is determined for a frame transmission of a location. The determination of a temporal position for the radar measurement may for example comprise determination of a time at which emission of the frame starts and ends, the time between the start and end being equal to an emission duration that may be dependent on a length of the frame and on an emission rate. The temporal position of each radar measurement may be distinct from the temporal positions of the other radar measurements and from the temporal positions at which a frame transmission of a location is planned.

During each radar measurement, the emission of the frame by a UWB sensor may therefore be temporally separated from the other frame transmissions/emissions of the other radar measurements and from the UWB exchanges of each location. This makes it possible to avoid collisions between the radar measurements and locations. Avoiding collisions makes it possible to reduce the risk that a radar measurement and/or location is false or not executable. The temporal separation of the frame emissions/transmissions therefore improves the precision of the UWB system, in its use and execution.

For each location, the respective time interval in which the location is carried out may consist of a series of time slots. The time slots of the series may have a substantially equal duration. Each slot may for example have a duration greater than or equal to 1 millisecond and/or less than or equal to 2 milliseconds. The duration of the slot may depend on the identifier involved in the location.

The number of time slots in the series may be dependent on the number of UWB sensors in the UWB system. The number of time slots may also be dependent on a constant of the UWB system and/or of the one or more identifiers. The constant may represent a number of slots at the start and end of the series. For example, the number of time slots in the series may be greater than or equal to the sum of the number of UWB sensors in the system and of the constant. The UWB system may comprise a predetermined series of numbers each configured for the UWB system, and the number of time slots may correspond to one of the numbers in the predetermined series, for example the number in the predetermined series that is closest and greater than or equal to the sum.

The one or more identifiers may comprise a priority identifier, i.e. a predetermined identifier or an identifier designated as such in the UWB system. When the one or more identifiers comprise a plurality of identifiers, the identifiers may comprise a priority identifier and one or more secondary identifiers. The priority identifier may have a priority operation in the locations, with respect to the one or more secondary identifiers. For example, planning of locations involving the priority identifier may take precedence over planning of locations involving the one or more secondary identifiers. The planning may comprise cancelling planning of a location involving one of the one or more secondary identifiers when the location is planned for the same time as a location involving the priority identifier is planned.

The planning may comprise, for each identifier, planning one or more locations among the locations involving the identifier in a respective session corresponding to one period. A session may have a duration that corresponds to a multiple of a predetermined time, for example once, twice, three times, or ten times 96 milliseconds. Each session may be divided into blocks. Each block may be divided into a plurality of time intervals, and a location involving the identifier may be carried out within one of these time intervals. Each of the time intervals may be divided into a series of time slots. For each identifier, the planning may therefore be based on series of slots respective to the identifier. The respective series of slots of the priority identifier may differ from the respective series of slots of the one or more secondary identifiers. The method of use and/or the scheduling method may comprise determination of the number of time slots in each series, the number of time intervals in each block, and/or the number of blocks per session for each identifier.

The planning may comprise planning each radar measurement within one of the time slots of one of the respective series of the priority identifier. The planning of the radar measurement within one of the time slots may comprise determination of the start time of emission of the frame within the slot and such that the end of the emission occurs before the end of the slot. In other words, the start time of emission is determined so that the emission ends before the end of the slot. The frames of each radar measurement may therefore be emitted within one of the time slots of the priority identifier.

For each identifier, the transmissions of frames of the UWB exchanges between the identifier and the one or more UWB sensors may be carried out within time slots of a series of the session of the identifier. For the priority identifier, for example, the transmissions of frames of the UWB exchanges between the identifier and the one or more UWB sensors may be carried out within time slots of a series of the session of the priority identifier. For example, each transmission may be carried out in a respective time slot. The time slots of the series in which one of the frame transmissions is carried out may form a first group. The series may also comprise a second group of one or more time slots outside the first group. For example, the number of frame transmissions of the UWB exchanges of each location may be strictly less than the number of time slots in the series, and in this case, the number of the one or more slots belonging to the second group may be equal to the difference between the number of time slots in each series and the number of frame transmissions of the UWB exchanges of the location. The use of time slots is therefore optimized.

The number of frame transmissions of the UWB exchanges of each location may be strictly less than the number of time slots in the series when the number rounding up is greater than or equal to zero in the following formula:

$$( 4 + N + X ) * K * C = T$$

with N the number of UWB sensors in the UWB system, K the duration of a time slot, C the number of time intervals per block, X the number rounding up and T a predetermined time (for example 96 milliseconds).

The planning of the plurality of radar measurements may comprise, for at least one radar measurement, planning the radar measurement within one of the one or more time slots belonging to the second group. The frames of the radar measurements may therefore each be emitted within one of the one or more time slots belonging to the second group (each in a respective slot of the second group). The planning of a radar measurement may comprise a selection of one of the one or more time slots of the second group and determination of the start time of emission of the frame within the selected slot. Whether a slot is selected may depend on the other radar measurements of the plurality. For example, the planning may assign each radar measurement to a respective slot of the second group.

Each frame of one of the UWB exchanges may be transmitted at the start of a respective time slot. For example, the planning of each location may comprise, for each frame transmission of the location, determination of a transmission start time to be substantially simultaneous with the start of the respective time slot in which the transmission is carried out.

Each frame of the radar measurement of the UWB sensor may be emitted at the end of a respective time slot. For example, the planning of each radar measurement may comprise determination of a start time of emission of the frame so that the end of the emission corresponds substantially to the end of the respective time slot in which the emission is carried out.

For each UWB sensor, the respective time slots in which the UWB sensor emits a frame of a radar measurement may be different from the respective slots in which a frame of a UWB exchange between one of the one or more identifiers and the UWB sensor is transmitted. Emission in a different slot allows the UWB sensor to have time to change configuration between the UWB exchange and the radar measurement. The time between the UWB exchange and the radar measurement may be greater than a predetermined time (for example greater than 1 millisecond). After transmission of the frame of the UWB exchange, the UWB sensor may change configuration to then emit the frame of the radar measurement and listen for the return signal. The method therefore reduces the risk, for each UWB sensor, that the time between transmission of a frame of a UWB exchange and emission of a frame of a radar measurement (and vice versa) is less than the time required to make this configuration change. This therefore contributes to improvement of the use of the UWB system, and in particular of the UWB sensors.

Furthermore, transmission of the frame of the UWB exchange at the start of a respective slot and emission of the frame of the radar measurement at the end of a respective slot allows a spacing of a duration at least equivalent to (or greater than) one time slot, this allowing the risk that the duration is less than the time required to change the configuration of the UWB sensor to be reduced.

The frames of the radar measurements may be emitted orthogonally to the transmitted frames of the UWB exchanges. Alternatively or additionally, the frames emitted by each UWB sensor may be orthogonal to the frames emitted by each of the other UWB sensors. The orthogonality may be obtained by any orthogonality-based frame emission/transmission method, so as to avoid interference with the frame emissions/transmissions. For example, the frames may comprise a first segment (for example a synchronization segment) comprising orthogonality parameters of the frame. The parameters may be used to decode the frame. Orthogonality also allows noise between the frames of the radar measurements and UWB exchanges to be reduced.

The scheduling method may comprise detection of at least one scheduling in a given time slot of emission of a frame of the radar measurement and of transmission of a frame of one of the UWB exchanges. To this end, the method may comprise an analysis of the planning of the one or more distance measurements and of the plurality of radar measurements. For example, the detection may comprise determination that the start time of the emission is expected between the start and end of the transmission and/or determination that the end of the emission is expected between the start and end of the transmission. For each of the at least one scheduling detected in a given time slot, the scheduling method may comprise a temporal shift of the scheduling of the emission of the frame of the radar measurement with respect to the transmission of the frame of the one of the UWB exchanges. The temporal shift may comprise computation of a shift duration so that the emission is scheduled before or after the transmission. For example, the emission may be planned to start at a time t₁, and the shift may comprise computation of a temporal shift Δt and new planning for the start of the emission at a time t₂=t₁+Δt. The temporal shift allows collision between the emitted frame of the radar measurement and the transmitted frame of the UWB exchange to be avoided, this improving utilization of the UWB system.

A UWB sensor for a vehicle UWB system is also provided. The UWB sensor is configured for a use of the system according to the method of use and/or to execute the scheduling method.

The UWB sensor may be configured to perform both the location and the radar measurements, and/or be programmed to do so. The UWB sensor may be configured to receive one or more commands (for example received from the UWB system) to transmit a frame of a UWB exchange and/or emit a frame of a radar measurement. The UWB sensor may be configured, after emission of a frame of a radar measurement, to change configuration before transmitting a frame of a UWB exchange or, after transmission of a frame of a UWB exchange, to emit a frame of a radar measurement. The UWB sensor may be configured to make this change, for example, in less than one millisecond.

A vehicle UWB system is also provided. The UWB system comprises one or more UWB sensors. The system is configured to be used according to the method of use and/or to execute the scheduling method. The UWB system may be configured, after the planning, to transmit one or more commands to each UWB sensor depending on the planning in an execution phase of the planning. The one or more commands may comprise a request to transmit a frame of a UWB exchange and/or to emit a frame of a radar measurement.

A computer program is also provided. The computer program comprises program-code instructions for execution of the method of use and/or of the scheduling method, when said program is executed by a processor. The computer program may be stored in a memory. The UWB system may comprise the processor and/or the memory.

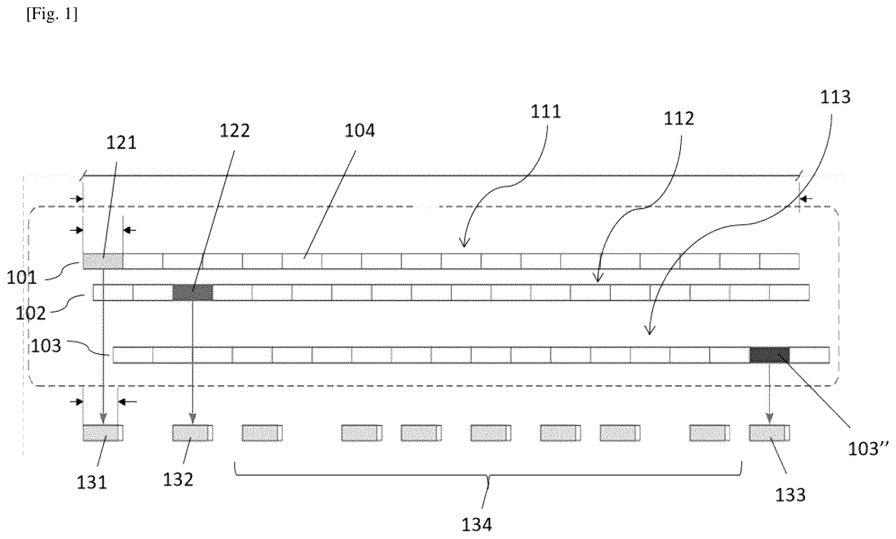

Examples will now be given with reference to FIGS. 1 to 10.

FIG. 1 shows one example of planning of a plurality of locations. FIG. 1 shows, for each identifier 101, 102, 103, a respective block 111, 112, 113. Each block may for example last 288 milliseconds. Each respective block 111, 112, 113 comprises eighteen time intervals 104. Each time interval may for example last 16 milliseconds. For each identifier, the method of use comprises a location 121, 122, 123 of the identifier with the one or more UWB sensors. The location 121 involves the identifier 101, the location 122 the identifier 102 and the location 123 the identifier 103. Each location includes an active RF portion (RF being the acronym of Radio-Frequency). The active RF portion corresponds to the segment of the time interval in which the location comprises UWB exchanges. In the figure, the active portion FT 131 corresponds to the location involving the identifier 101, the active portion FT 132 corresponds to the location involving the identifier 102 and the active portion FT 133 corresponds to the location involving the identifier 103. The figure also shows other active portions FT 134 corresponding to the location involving other identifiers that have not been shown.

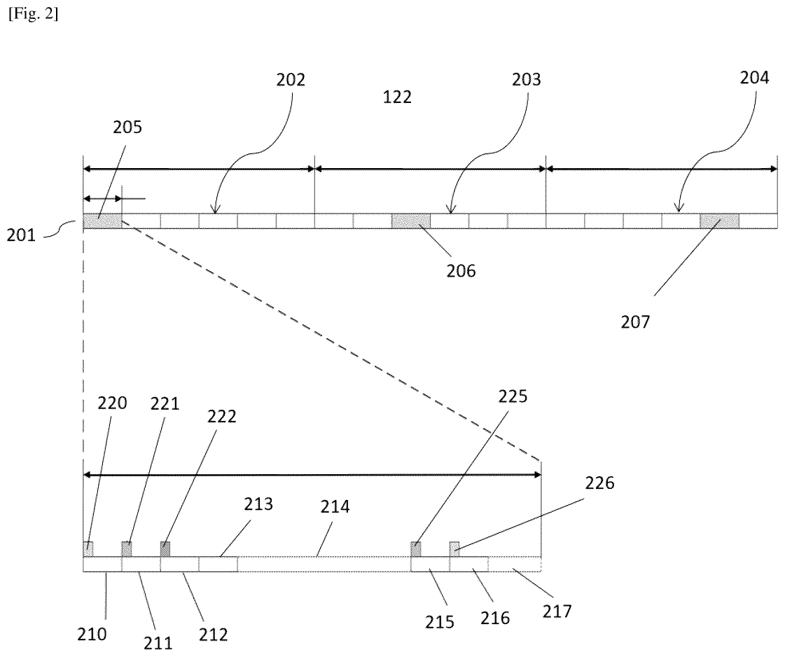

FIG. 2 shows one example of a location carried out within a time interval consisting of a series of time slots. The figure shows a session 201 of an identifier. The session may comprise, for example, three blocks 202, 203, 204, each comprising, for example, six time intervals. The method of use comprises a respective location for each of the three blocks. For each block, the location is carried out within one of the six time intervals of the block (the time interval 205 for block 202, the time interval 206 for block 203 and the time interval 207 for block 204).

The location carried out within the interval 205 will now be discussed in more detail. The other locations may be carried out in the same way. The time interval 205 consists of a series of time slots 210, 211, 212, 213, 214, 215, 216, 217. The identifier involved in the location may be a priority identifier or a secondary identifier. The location carried out within the interval 205 comprises UWB exchanges between the identifier and the one or more UWB sensors. Each UWB exchange consists of transmissions of frames between the identifier and the one or more UWB sensors. The transmissions of frames of the UWB exchanges between the identifier and the one or more UWB sensors are carried out within slots of the series belonging to a first group. The first group consists of time slots 210, 211, 212, 214, 215 and 216. The transmission of frame 220 is carried out in slot 210, the transmission of frame 221 in slot 211 and the transmission of frame 222 in slot 212. Frames 220, 221 and 222 are sent from the identifier to each of the one or more identifiers. In the time slots 214, each of the one or more identifiers carries out a respective transmission of a frame to the identifier. Next, the transmission of frame 225 is carried out in slot 215 and the transmission of frame 226 in slot 216. Frames 225 and 226 are transmitted from the identifier to each of the one or more identifiers. Frames 220, 221, 222, 225 are transmitted at the start of the time slots 210, 211, 212, 215. The series also comprises a second group of one or more slots 213, 217 outside the first group. At least one frame of the radar measurement may be emitted within one of the one or more slots of the second group 217.

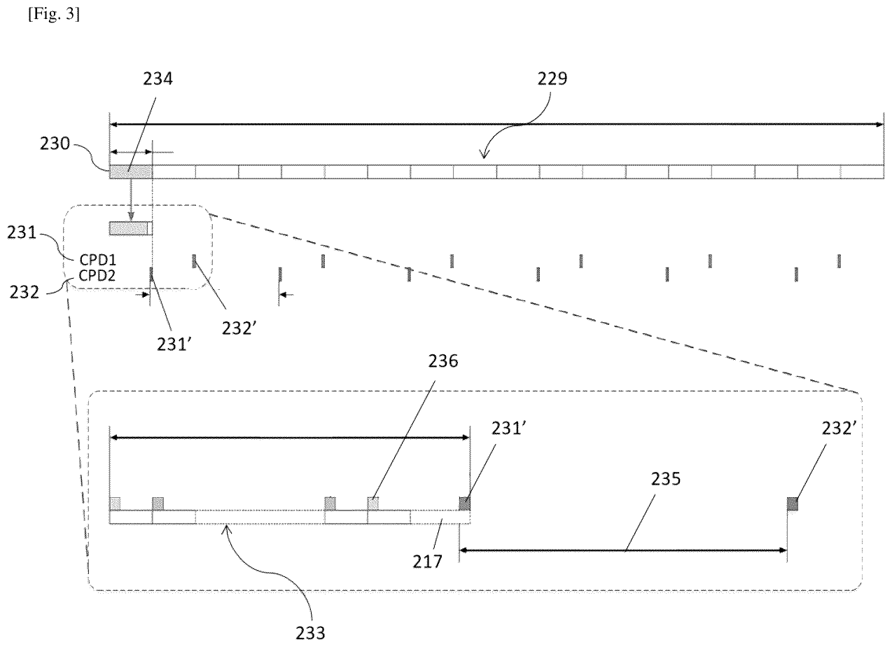

FIG. 3 shows a first example of planning of a plurality of radar measurements. FIG. 3 shows a session 230 of an identifier, and in particular a block 229 of this session. The block 229 comprises 18 time intervals. In this first example, the method comprises a plurality of radar measurements. The plurality of radar measurements includes, for two UWB sensors 231, 232 (“CPD1” and “CPD2”), a plurality of respective radar measurements. The number of respective radar measurements is, for each identifier, greater than the number of at least one respective location 234 of the identifier with the one or more UWB sensors. The figure shows the session 230 of the priority identifier, and in particular the series 233 of time slots of the time interval in which the location 234 involving the priority identifier is carried out. The radar measurements 231′, 232′ are carried out within time slots of the series 233 of the priority identifier. Each radar measurement comprises emission of a frame within one of the one or more slots belonging to the second group 217. The UWB sensor 231 emits the frames 231′ and the UWB sensor 232 the frames 232′. The frames 231′ and 232′ are emitted within one of the slots 217 belonging to the second group. The duration between two radar measurements 235 is substantially equal to the duration of the time interval of the location 234, i.e. 16 milliseconds in this example. The frames 231′, 232′ of the radar measurements of each of the UWB sensors 231, 232 are emitted at the end of one of the slots 217. The time between transmission of the frame 236 and emission of the frame 231′ is greater than 1 millisecond.

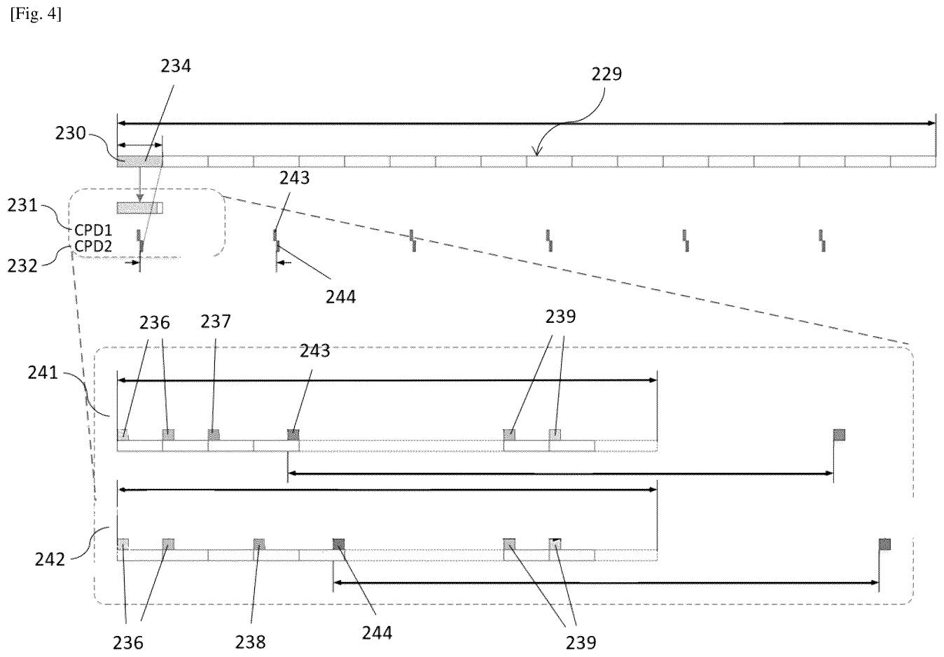

FIG. 4 shows a second example of planning of a plurality of radar measurements. FIG. 4 also shows a session 230 of an identifier, and in particular a block 229 of this session comprising 18 time intervals. In this second example, for each of the UWB sensors, the respective time slots in which the UWB sensor emits a frame of a radar measurement are different from the respective time slots in which a frame of a UWB exchange is transmitted between one of the one or more identifiers and the UWB sensor. The figure shows, in this example, in the time interval of the location 234, the UWB exchanges between the identifier of the session 230 and two UWB sensors 231, 232. The figure shows in detail the frame transmissions/emissions 241 for the UWB sensor 231 and the frame transmissions/emissions 242 for the UWB sensor 232 during the location 234.

The location 234 comprises two transmissions of frames 236 from the identifier of the session 230 to each of the two UWB sensors 231, 232 in slots (“0” and “1”) at the start of the series of slots of the interval. The frames are transmitted from the identifier to each of the UWB sensors, and the figure shows the frames 236 received by each of the UWB sensors 241, 242. For each UWB sensor, the location 234 then comprises transmission of a frame from the UWB sensor to the identifier in a respective slot in the middle of the series. The location comprises a first transmission of a frame 237 from the UWB sensor 241 to the identifier in slot “2” and a second transmission of a frame 238 from the UWB sensor 242 to the identifier in slot “3”. The location then comprises two transmissions of frames 239 from the identifier of the session 230 to each of the two UWB sensors 241, 242 in slots at the end of the series (“Nresp+2” and “Nresp+3”). The UWB sensor 231 emits a frame 243 in slot “3”.

Each of the frames 236, 237, 238 and 239 is transmitted at the start of the respective slot (“0”, “1”, “2”, “3”, “Nresp+2”, “Nresp+3”) in which it is transmitted and each of the frames 243, 244 is emitted at the end of the respective slot (“3”, “4”) in which it is emitted. The UWB sensor 241 emits a frame 243 of a radar measurement in slot “3”. The UWB sensor 241 therefore emits the frame 243 in a slot that differs from the slots “0”, “1”, “2”, “Nresp+2”, “Nresp+3” in which a frame of a UWB exchange involving the UWB sensor 231 is transmitted. Likewise, for the UWB sensor 242, the latter emits a frame 244 of a radar measurement in slot “4” and this slot “4” differs from the slots “0”, “1”, “3”, “Nresp+2”, “Nresp+3” in which a frame of a UWB exchange involving the UWB sensor 232 is transmitted. For the UWB sensor 231, the duration between transmission of frame 237 to the identifier and emission of frame 243 of the radar measurement is greater than 1 millisecond. This duration allows the UWB sensor 231 to change configuration between the UWB exchange and the radar measurement. Likewise, for the UWB sensor 232, the duration between transmission of frame 238 to the identifier and emission of frame 244 of the radar measurement is greater than 1 millisecond, this allowing the UWB sensor 232 to change configuration between the UWB exchange and the radar measurement.

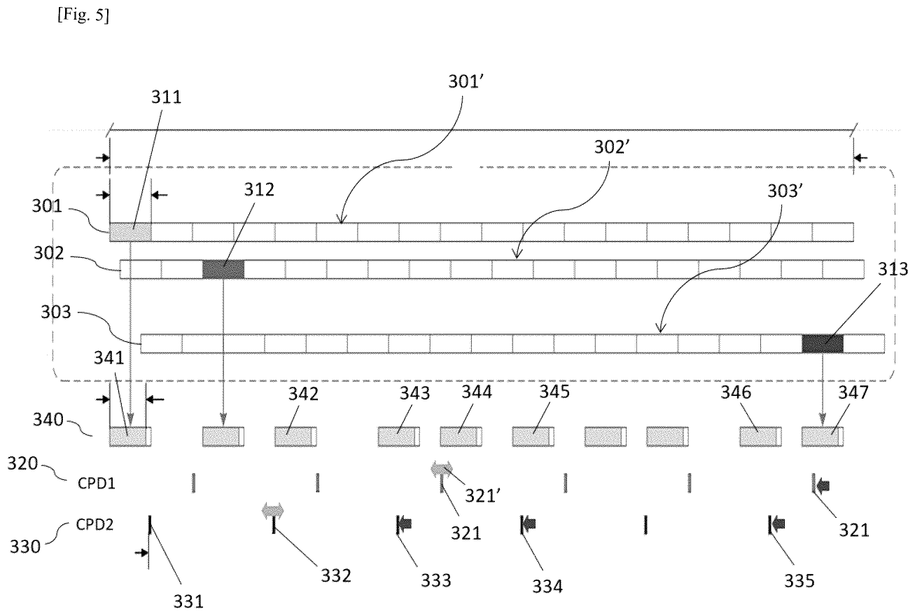

FIG. 5 shows a third example of planning of a plurality of radar measurements. The figure shows planning of a respective location for each identifier in a session. In particular, the figure shows the sessions of three identifiers 301, 302, 303. For each identifier 301, 302, 303, the figure shows one block 301′, 302′, 303′ of the session of the identifier each comprising 18 time intervals. The location 311 involves the identifier 301, which is the priority identifier in this example, and is carried out in the first time interval of block 301′ of the session of the identifier 301. The location 312 involves the identifier 302 and is carried out in the third time interval of block 302′ of the session of the identifier 302. The location 313 involves the identifier 303 and is carried out on the penultimate time interval of block 303′ of the session of the identifier 303. The figure also shows the active RF portion 340 of each location. The figure also shows the plurality of radar measurements planned for the UWB sensors 320 (“CPD1”) and 321 (“CPD2”).

The scheduling method comprises detection of at least one scheduling in a given time slot of a respective emission of a frame of the radar measurement and of transmission of a frame of one of the UWB exchanges. For each of the at least one scheduling detected in a given time slot, the scheduling method comprises a temporal shift of the scheduling of the emission of the frame of the radar measurement with respect to the transmission of the frame of the one of the UWB exchanges. For example, the scheduling method comprises detection of whether the radar measurement 321 by the UWB sensor 320 is planned for the same time as the location 344 and for a time slot already used by a UWB exchange involving the UWB sensor 320. The scheduling method may then comprise a shift 321′ of the radar measurement 321 to another time slot that is not in use by the UWB sensor 320 (for example to a time slot of the second group or a slot used by a UWB exchange involving another sensor). Alternatively, the scheduling method may comprise a shift 321′ of the radar measurement 321 outside location 344, for example achieved here by advancing the radar measurement 321 so that it is carried out before location 344. The scheduling method comprises analogous steps to prevent radar measurement 331 from being scheduled for the same time as 341 (measurement 331 delayed), radar measurement 332 from being scheduled for the same time as 342 (measurement 332 advanced or delayed), measurement 333 from being scheduled for the same time as 343 (measurement 333 advanced to a time slot of the second group or to a slot used by a UWB exchange not involving sensor 330), radar measurement 334 from being scheduled for the same time as 345 (measurement 334 advanced to a time slot of the second group or a slot used by a UWB exchange not involving sensor 330), radar measurement 335 from being scheduled for the same time as 346 (measurement 335 advanced to a time slot of the second group or to a slot used by a UWB exchange not involving sensor 330) and radar measurement 321 from being scheduled for the same time as 347 (measurement 335 advanced to a time slot of the second group or to a slot used by a UWB exchange not involving sensor 320).

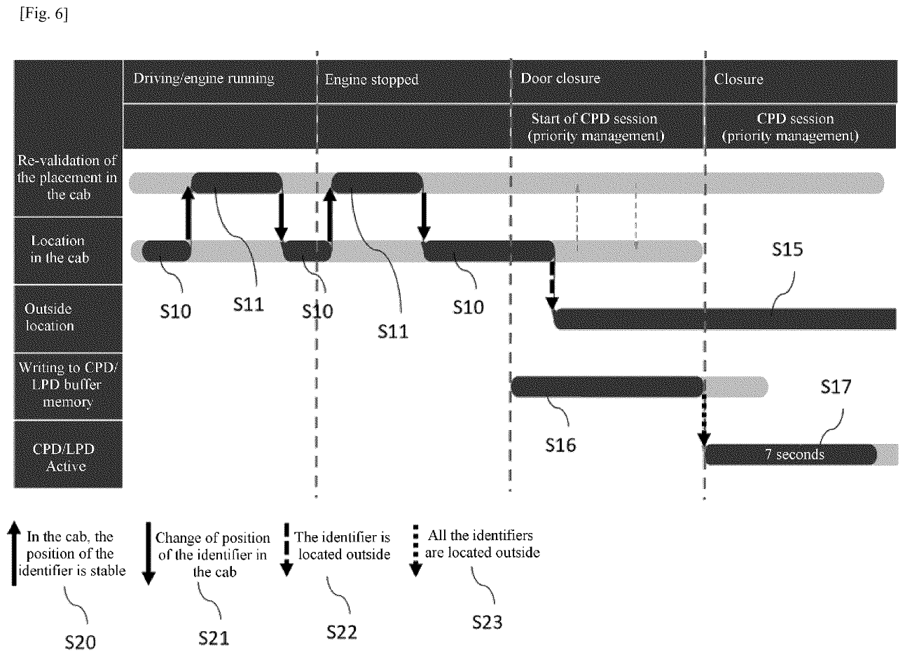

FIG. 6 shows one example of a use of the vehicle based on locations and radar measurements planned according to the scheduling method.

While the vehicle is being driven/engine of the vehicle is running, the use comprises a location S10 in the cab of the identifier. After a stable position S20 of the identifier in the cab, the use comprises re-evaluation S11 of the placement of the identifier in the cab. Next, the use comprises a change S21 of the position of the identifier in the cab then a new location S10 of the identifier in the cab. After the engine has stopped, the use comprises again a stable position S20 of the identifier in the cab, a re-evaluation S11 of the placement of the identifier in the cab, then a change S21 of the position of the identifier in the cab followed by a new location S10 of the identifier in the cab. At the time of door closure, the use comprises writing to CPD/LPD buffer memory S15. The use also comprises an outside location S15 of all the identifiers after the identifier is located S22 outside. The use also comprises an active CPD/LPD time S17 after closure, simultaneously with location S23 of all the identifiers outside the vehicle. At the time of closure, the use may comprise one or more radar measurements to verify the absence of occupants who might have remained in the vehicle after closure.

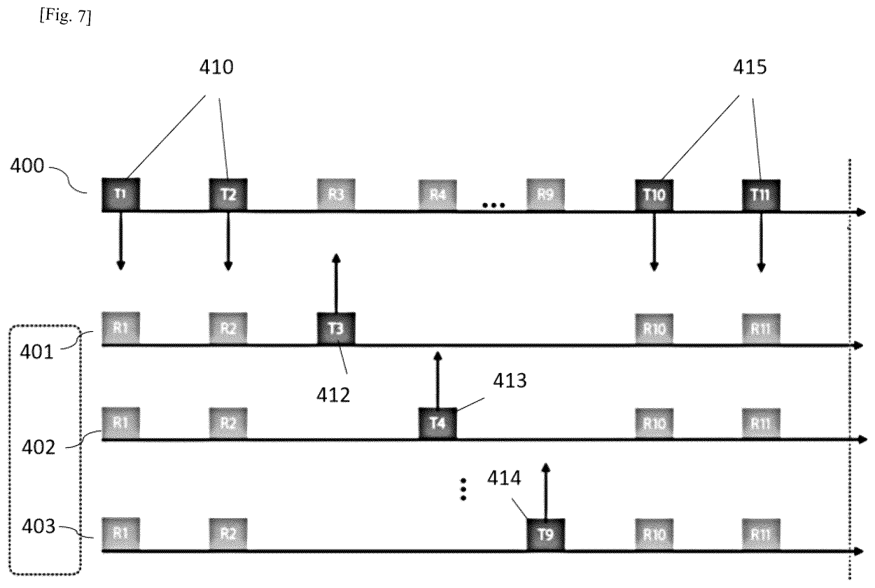

FIG. 7 shows one example of location of an identifier with the one or more UWB sensors. The location comprises two transmissions 410 of a frame in two first time slots from the identifier 400 to each of the UWB sensors 401, 402, 403. The location then comprises, successively and in a respective time slot, transmission of a frame by each of the UWB sensors (frame 412 for 401, frame 413 for 402 and frame 414 for 403). The location next comprises two transmissions 415 of a frame in two last time slots from the identifier 400 to each of the UWB sensors 401, 402, 403.

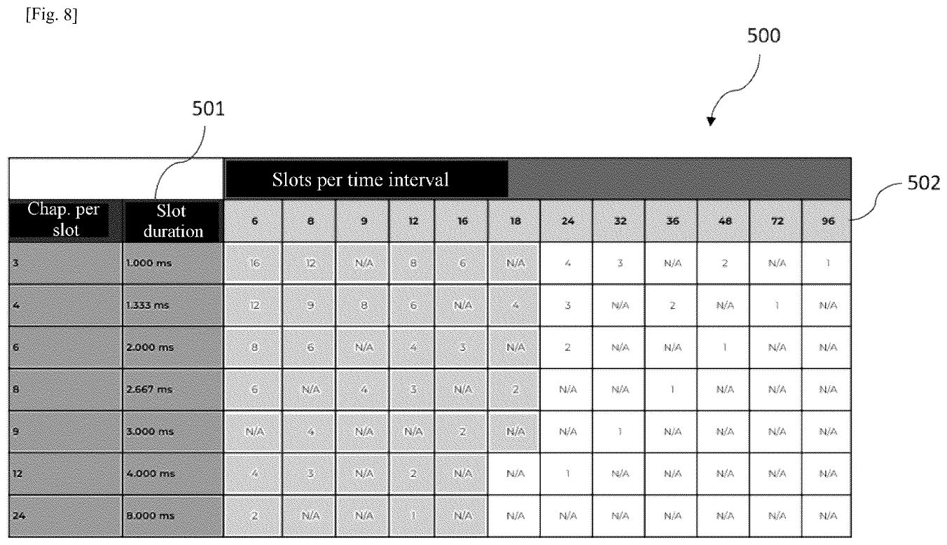

FIG. 8 shows one example of determination of the number of time slots of each series for an identifier. The determination may be based on application of a standard, for example using table 500. The determination comprises determination of a time-slot duration 501 for the identifier. For example, the identifier may communicate its duration to the UWB system. Table 500 comprises a series of numbers 502 each configured for the UWB system. The determination comprises determination of a number of time slots per time interval based on the series 502. The number of time slots corresponds to the number of the predetermined series that is closest and greater than or equal to the sum of the number of UWB sensors in the system and of a constant (4 for example). Table 500 also comprises the number of time intervals per block as a function of the time-slot duration and of the number of time slots per series. For example, in this table 500, for a time-slot duration of 1 millisecond and 12 time slots per series, the number of time intervals per block is 8. The determination may comprise determination of a number of time intervals per block depending on the time-slot duration and on the number of time slots per time interval.

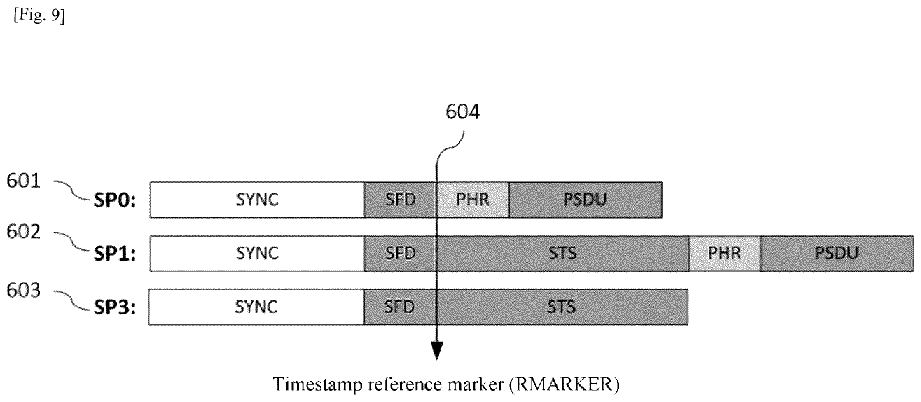

FIG. 9 shows three examples of frames 601, 602, 603. Each of the examples comprises a first segment “SYNC” and “SFD” and a marker 604. After the marker 604, each example comprises a second segment comprising, for the first example, a segment “PHR” and “PSDU”, for the third example, a segment “STS”, and for the second example, a segment “STS” followed by a segment “PHR” and “PSDU”. The first example 601 may be a frame transmitted during a UWB exchange between the identifier and a UWB sensor. The third example 603 may be an emitted frame of a radar measurement.

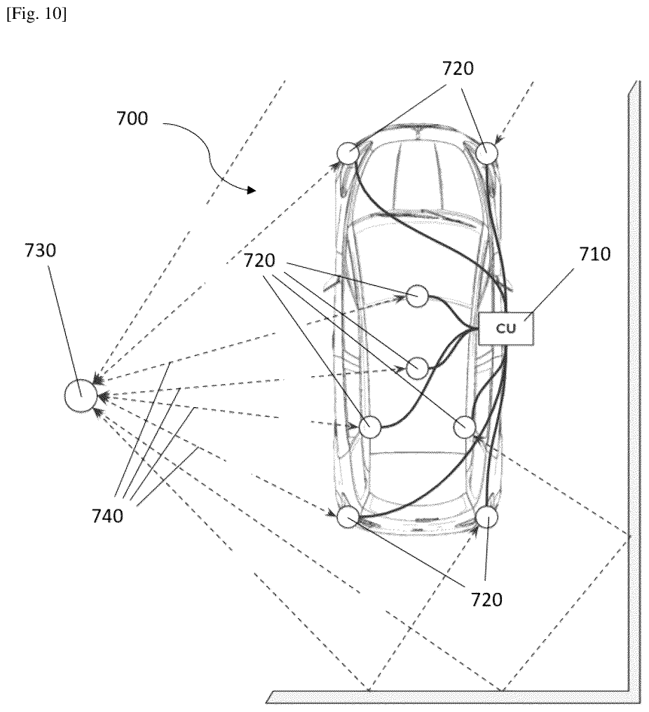

FIG. 10 shows one example of a UWB system 710 of a vehicle 700. The UWB system comprises a plurality of UWB sensors 720 positioned at the front of the vehicle, at the rear of the vehicle or indeed in the cab of the vehicle. The figure also shows an identifier 730. A location comprises UWB exchanges 740 between the identifier 730 and each of the UWB sensors 720.

1. A method of use of a vehicle Ultra-Wide Band (UWB system comprising one or more UWB sensors and having enrolled one or more identifiers, the method comprising periodically:
separating temporally one or more locations,
wherein the one or more locations comprising, for each respective identifier, at least one respective location of the respective identifier with the one or more UWB sensors; and
carrying out a plurality of radar measurements,
wherein the plurality of radar measurements comprise, for at least one respective UWB sensor, a plurality of respective radar measurements,
the plurality of respective radar measurements being, for each identifier, greater than the number of at least one respective location of the identifier with the one or more UWB sensors.

2. The method according to claim 1,
wherein each respective location of a respective identifier with the one or more UWB sensors comprises UWB exchanges each consisting of transmissions of frames between the respective identifier and the one or more UWB sensors,
wherein the plurality of radar measurements comprise:
for each respective radar measurement of a respective UWB sensor, emission of a frame by the respective UWB sensor,
said emission being temporally separated from the transmissions of frames between the respective UWB sensor and the respective identifier during the UWB exchanges.

3. The method according to claim 2, further comprising
carrying out each respective location of a respective identifier with the one or more UWB sensors within a time interval consisting of a series of time slots, and
wherein the one or more identifiers comprise a priority identifier; and
emitting the frames of each radar measurement within one of the time slots of the priority identifier.

4. The method according to claim 3, further comprising:
carrying out the transmissions of frames of the UWB exchanges between the priority identifier and the one or more UWB sensors within slots of the series belonging to a first group,
wherein the series comprising a second group of one or more slots outside the first group; and
emitting at least one frame of the radar measurement within one of the one or more slots of the second group.

5. The method according to claim 3, further comprising:
transmitting each frame of one of the UWB exchanges at the start of a respective time slot;
emitting each frame of the radar measurement of the UWB sensor at the end of a respective time slot; and
for each UWB sensor,
emitting, by the respective time slots in which the UWB sensor, a frame of a radar measurement different from the respective time slots; and
transmitting a frame of a UWB exchange between one of the one or more identifiers and the UWB sensor.

6. The method according to claim 2, further comprising:
emitting the frames of the radar measurements orthogonally to the transmitted frames of the UWB exchanges.

7. The method according to claim 2, wherein each respective location of a respective identifier with the one or more UWB sensors comprises:
transmissions of frames from the identifier to each UWB sensor in slots at the start and end of the series, and
for each UWB sensor, transmission of a frame from the UWB sensor to the respective identifier in a respective slot in the middle of the series.

8. A scheduling method implemented by a vehicle UWB system comprising one or more UWB sensors and having enrolled one or more identifiers, for a use of the vehicle UWB system according to the method of claim 1, the scheduling method comprising planning of the one or more locations and the plurality of radar measurements.

9. The scheduling method according to claim 8, further comprising:
detecting at least one scheduling in a given time slot of emission of a frame of the radar measurement and of transmission of a frame of one of the UWB exchanges; and
for each of the at least one scheduling detected in a given time slot,
shifting temporally the scheduling of the emission of the frame of the radar measurement with respect to the transmission of the frame of the one of the UWB exchanges.

10. A vehicle UWB system comprising one or more UWB sensors and configured to be used according to the method of claim 1 and/or to execute a scheduling method comprising:
planning of the one or more locations and the plurality of radar measurements.

11. A UWB sensor for a vehicle UWB system and configured for a use of the system according to the method of claim 1 and/or to execute the scheduling method comprising:
planning of the one or more locations and the plurality of radar measurements.

12. A computer program comprising program-code instructions for the execution of the method according to claim 1 and/or the scheduling method comprising planning of the one or more locations and the plurality of radar measurements, when said program is executed by a processor.
